(19) United States
(12) Patent Application Publication
(10) Pub. No.: US 2026/0248590 A1
(43) Pub. Date: Aug. 27, 2026

(54) ENDODONTIC APPARATUS AND METHOD OF USING THE SAME

(71) Applicant: KING SAUD UNIVERSITY, RIYADH (SA)

(72) Inventor: NAIF HAMAD ALOTAIBI, RIYADH (SA)

(21) Appl. No.: 19/222,123

(22) Filed: May 29, 2025

Related U.S. Application Data
(62) Division of application No. 19/061,174, filed on Feb. 24, 2025.

(51) Int. Cl. A61C 5/46

(52) U.S. Cl. CPC A61C 5/46

(57) ABSTRACT

A dental apparatus includes a handle, a dental excavator and a connecting member connecting the dental excavator and the handle to one another. The dental excavator includes a first end, a second end opposite to the first end, and a sidewall extending between said first and second ends, the second end of the dental excavator being connected to the connecting member. The sidewall of the dental excavator is curved along a first direction that is transverse to a second direction in which said sidewall extends. The sidewall defines an inner concave side surface of the dental excavator and an outer convex side surface of the dental excavator. The sidewall of the dental excavator is wider at the second end thereof than at the first end thereof.

### CROSS-REFERENCE TO RELATED APPLICATION

This application is a divisional of U.S. patent application Ser. No. 19/061,174, filed on Feb. 24, 2025, the entire contents of which are incorporated herein by reference.

### TECHNICAL FIELD

The present disclosure relates to endodontics, and more particularly, to an apparatus configured for use in an endodontic procedure and a method of using the same.

### DISCUSSION OF THE RELATED ART

A root canal procedure is generally performed when caries in a tooth enlarges and approaches or reaches the pulp (or nerve tissue) inside of the tooth. Endodontists use various types of hand and/or power instruments to remove the pulp from the crown and from the root canals of a tooth. The root canals are then sealed with an inert material, which typically includes gutta-percha by itself or in combination with other sealant(s).

In some instances, a root canal procedure fails after a period of time. Depending on the condition of the tooth, an endodontist may advise the patient to redo the root canal procedure. The redoing process is called a “retreat” in medical terms. A root canal retreat procedure is lengthy, in part because the endodontist must remove the sealing material previously inserted in the root canals of the tooth.

The removal of the sealant can be described as a two part process. The first part includes removing the sealant in bulk from the root canals. The second part includes removing small pieces of sealant material that remain lodged to the inner side surface of the root canals after the bulk removal. The second part is particularly lengthy because the endodontist should remove all of the small pieces of gutta-percha and other sealants that are adhered to the inner side surface of the root canals before medicating the root canals and sealing them again.

Dentists believe that the complete removal of the small pieces of sealant material that are adhered to the inner side surface of the root canals is a prerequisite for a successful root canal retreat procedure. Since the pieces of sealant material are small and scattered throughout the interior of the root canals, the process of removing them one by one in a careful manner without causing undue damage to the root canals is lengthy and tedious.

### SUMMARY

The present disclosure relates to a hand tool configured to be used in dentistry to remove the small pieces of sealant material that are adhered to the inner side surface of the root canals in a rapid and safe manner. The present subject matter also relates to a method of operating the hand tool to remove the sealant pieces from the root canals.

The dental hand tool of the present subject matter includes a handle, a dental excavator and a connecting piece that serves to connect the handle with the dental excavator. The dental excavator can be made of a metal. The dental excavator resembles a slice of a funnel cut along the length of the funnel. Stated differently, the dental excavator can resemble a section of a pipe that has been cut in half along its length, with the pipe being wider at the end thereof connected to the connecting piece than at its distal end, located away from the connecting piece. That is, the width of the dental excavator decreases in a direction away from the connecting piece. Another way to describe the configuration of the dental excavator is to start with the shell of a hollow cone and cutting a slice of the shell along the length direction of the cone. The slice that is cut resembles the shape of the dental excavator.

The dental excavator may be substantially longer than wider at its widest point, and is sized to fit inside of a root canal. The dental excavator can be inserted inside of a root canal (by an endodontist grasping the handle and directing the dental excavator toward the root canal) to remove pieces of sealant material from the canal's interior surface by rotating the handle. That is, the rotating motion imparted by the endodontist's hand on the handle of the tool causes the dental excavator inside of the root canal to rotate, and the rotation of the dental excavator inside of the root canal removes, or dislodges, the pieces of sealant material from the inner side surface of the root canal.

The curvature of the dental excavator in the width direction in combination with the length of the dental excavator (which may extend along a major portion of the length of a root canal or along the entire length of the root canal) enables a rapid and safe removal of the sealant material and/or decayed tooth material from the root canal.

Therefore, the dental tool of the present subject matter can be used to reduce the amount of time spent performing a root canal retreat procedure while preventing damage to the root canals, thereby contributing toward the success of the retreat procedure.

The term “hand tool” is used to describe the apparatus of the present subject matter because the dental excavator is intended to be rotated inside of a root canal by a rotation motion imparted on the handle by the dentist's hand. This is different from power tools, in which the rotation motion is imparted on the working part of the tool by an electrical motor or other means which require electrical power to operate.

### BRIEF DESCRIPTION OF THE DRAWINGS

The above and other features of the present disclosure will become more apparent by describing in detail exemplary embodiments thereof in conjunction with the accompanying drawings, in which:

FIG. 1 is a side view illustrating a dental apparatus in accordance with an embodiment of the present subject matter;

FIG. 2 is a magnified side view illustrating a region A of FIG. 1;

FIG. 3 is a perspective view illustrating a dental excavator shown in FIG. 2;

FIG. 4 is a cross-sectional view taken along line A-A of FIG. 2;

FIG. 5 is a perspective view illustrating a dental excavator of a dental apparatus in accordance with an embodiment of the present subject matter;

FIG. 6 is a side view illustrating a dental excavator of a dental apparatus in accordance with an embodiment of the present subject matter;

FIG. 7 is a side view illustrating a dental apparatus in accordance with an embodiment of the present subject matter;

FIG. 8 is a side view illustrating a dental apparatus in accordance with an embodiment of the present subject matter;

FIG. 9 is a side view illustrating a dental excavator of a dental apparatus in accordance with an embodiment of the present subject matter;

FIG. 10 is a side view illustrating a dental apparatus in accordance with an embodiment of the present subject matter; and

FIG. 11 is a cross-sectional view of a tooth including a dental excavator of a dental apparatus inserted in a root canal of the tooth.

### DETAILED DESCRIPTION OF THE EMBODIMENTS

Exemplary embodiments of the present disclosure will be described more fully hereinafter with reference to the accompanying drawings. The present disclosure may, however, be embodied in different forms and should not be construed as being limited to the embodiments set forth herein. Like reference numerals may refer to like elements throughout the specification. The sizes and/or proportions of the elements illustrated in the drawings may be exaggerated for clarity.

When an element is referred to as being disposed on another element, intervening elements may be disposed therebetween. In addition, elements, components, parts, etc., not described in detail with respect to a certain figure or embodiment may be assumed to be similar to or the same as corresponding elements, components, parts, etc., described in other parts of the specification.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” may include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

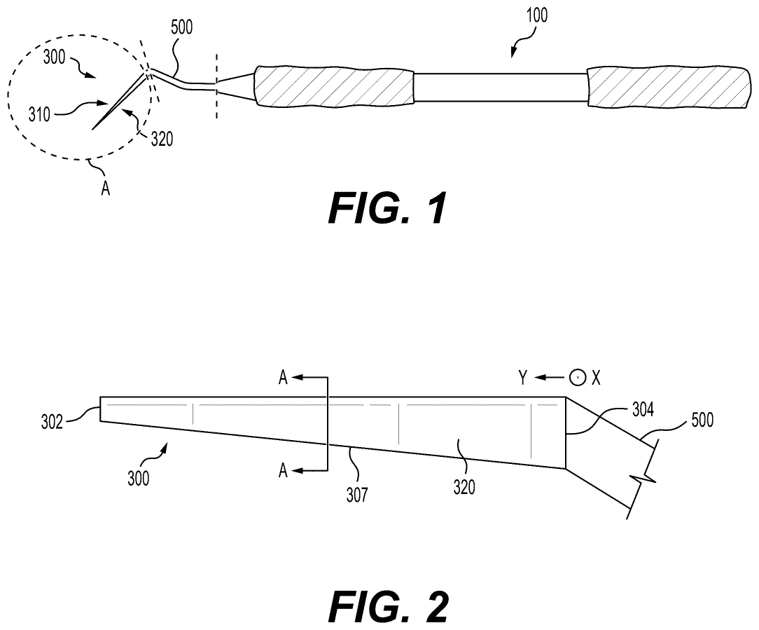

Referring to FIGS. 1-4, a dental apparatus includes a handle 100, a dental excavator 300 and a connecting member 500 connecting the dental excavator 300 and the handle 100 to one another.

The handle 100, the dental excavator 300 and the connecting member 500 may be made of a metal or of an alloy of metals. The metal or alloy thereof should be substantially inert when coming in contact with bodily tissue and bodily fluids, and should withstand repeated sterilization processes without experiencing undue structural or surface degradation. The metal/alloy may include, for example, stainless steel (such as surgical grade stainless steel), titanium, nickel, chromium, etc.

The connecting member 500 is an elongated structure (e.g., a round bar, whether solid or hollow in cross-section) that connects the dental excavator 300 with the handle 100. The connecting member 500 may have a bent shape, as illustrated in FIG. 1.

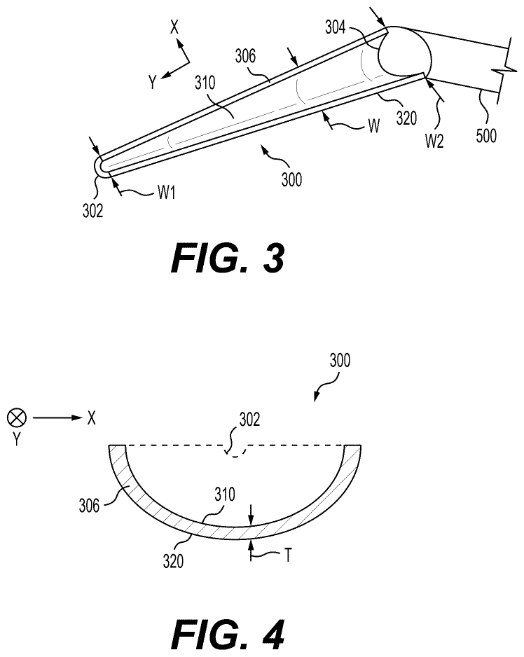

As illustrated in FIGS. 2-3, the dental excavator 300 includes a first end 302, a second end 304 opposite to the first end 302, and a sidewall 306 extending between the first and second ends 302, 304. The second end 304 of the dental excavator 300 is connected to the connecting member 500.

Referring to FIGS. 2-4, the sidewall 306 of the dental excavator 300 is curved along a first direction X that is transverse to a second direction Y in which the sidewall 306 extends. The first direction X and the second direction Y may extend perpendicularly to one another.

A centerline of the sidewall 306 in the length direction of the sidewall 306 may extend along the second direction Y.

The sidewall 306 defines an inner side surface 310 of the dental excavator 300 and an outer side surface 320 of the dental excavator 300.

The dental excavator 300 may include a thin enhancing coating formed on its exterior. The enhancing coating may be, for example, a titanium coating, a diamond-like carbon (DLC) coating, etc. The enhancing coating may reduce friction between the dental excavator 300 and a root canal of a tooth, and may increase the wear resistance of the dental excavator 300 during use.

The inner side surface 310 is concave in the first direction X along a length of the sidewall 306, between the first and second ends 302, 304 of the dental excavator.

The outer side surface 320 of the dental excavator 300 is disposed opposite to the inner side surface 310 thereof, and extends between the first and second ends 302, 304 of the dental excavator 300. The outer side surface 320 is convex in the first direction X along the length of said sidewall, between the first and second ends 302, 304 of the dental excavator 300.

Referring to FIG. 4, a thickness “T” of the sidewall 306 separates the inner and outer side surfaces 310, 320 from one another.

Referring to FIG. 4, the cross-section of the sidewall 306 tracks along a curved line. This configuration enables both the inner side surface 310 and the outer side surface 320 to be exposed to the outside. For example, the cross-section of the sidewall 306 may track along a portion of a circle (as contrasted from tracking along an entire circle, which would define a round bar), along a portion of an oval shape, along the portion of an ellipse, etc. This cross-sectional shape is efficient in dislodging pieces of sealant material from the inner side surface of a dental root canal when the dental excavator 300 is rotated in the root canal.

Referring to FIG. 2, the sidewall 306 of the dental excavator 300 may be wider at the second end 304 than at the first end 302. The width of the sidewall 306 can be measured along the first direction X, that is, the transverse direction. For example, FIG. 2 illustrates that a width W2 of the sidewall 306 and the second end 304 of the sidewall 306 is greater than a width W1 of sidewall 306 at the first end 302 thereof.

As illustrated in FIG. 3, a width “W” of the sidewall 306 of the dental excavator 300 may be reduced gradually in the second direction Y, from the second end 304 toward the first end 302.

As illustrated in FIGS. 2-3, the width “W” of the sidewall 306 of the dental excavator 300 is greater than zero at the first end 302. For example, the first width W1 is greater than zero. Stated otherwise, the dental excavator 300 might not be reduced to a point at its distal end 302. However, the present subject matter is not limited to this configuration.

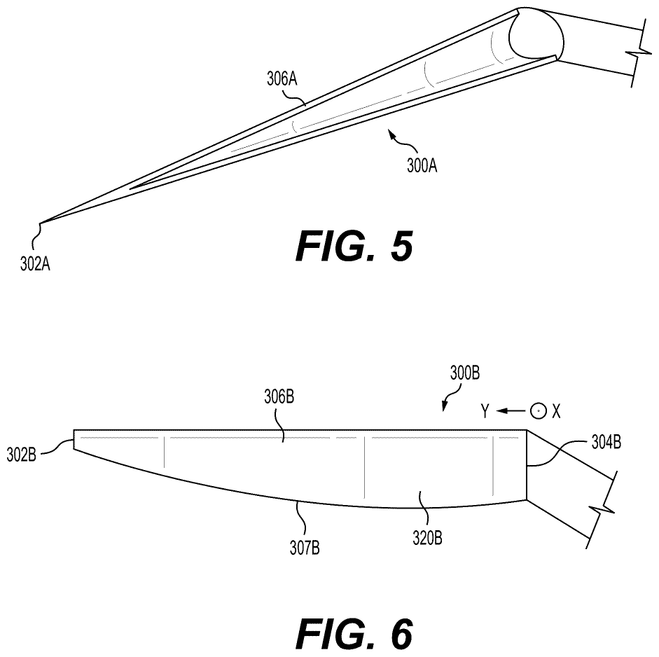

For example, and with reference to FIG. 5, a sidewall 306A of a dental excavator 300A can be reduced to a point at a first end 302A. That is to say, the sidewall 306A can taper down to a point at the end 302A. Stated otherwise, the width of the sidewall 302A of the dental excavator 300A may be substantially zero at the first end 302A.

The sidewall 306 of the dental excavator 300 may have a straight profile between the first and second ends 302, 304 of the dental excavator. For example, as illustrated in the side view of FIG. 2, which is a profile view, a bottom line 307, tracking along the bottom of the outer side surface 320 of the sidewall 306, may be straight. Stated otherwise, the bottom line 307 might not belly up or belly down in a profile view. However, the present disclosure is not limited to this configuration.

For example, and with reference to FIG. 6, which illustrates a profile side view of a dental excavator 300B, a sidewall 306B of the dental excavator 300B may have a curved profile between the first and second ends 302B, 304B of the dental excavator 300B. Referring to FIG. 6, a bottom line 307B, tracking along the bottom of the outer side surface 320B of the sidewall 306B, may be curved.

As illustrated in FIG. 6, the curvature of the profile of the dental excavator 300B, or the curvature of the bottom line 307B, may be convex in the second direction Y in which the dental excavator 300B extends. Therefore, the outer surface 320B of the dental excavator 300B may be convex in the second (or length) direction Y and convex in the first (or width) direction X. Stated otherwise, the outer side surface 320B may define a convex curve in the profile of the dental excavator 300B, as illustrated in FIG. 6.

While the inner side surface of the dental excavator 300B is not visible in the profile view of FIG. 6, the inner side surface of the dental excavator 300B may be concave in the second (or length) direction Y and concave in the first (or width) direction X. This is because the inner and outer side surfaces of the dental excavator 300B are opposite to one another and are separated from one another by the thickness of the dental excavator 300B, similarly to the first and second side surfaces 310 and 320 of the dental excavator 300.

Similarly to the dental excavator 300, the dental excavator 300B may be wider at the second end 304B thereof than at the first end 302B thereof. All other aspects/features of the dental excavator 300B not described in detail herein may be assumed to be similar to or the same as corresponding aspects/features of the dental excavator 300, except where the context clearly indicates otherwise.

Since the first end 302B is shown as a vertical cutout drop in the profile view of FIG. 6, then a width of the sidewall 306B of the dental excavator 300B is greater than zero at the first end 302B. However, a dental excavator of the present subject matter that has a convexly-shaped bottom profile is not limited to this configuration.

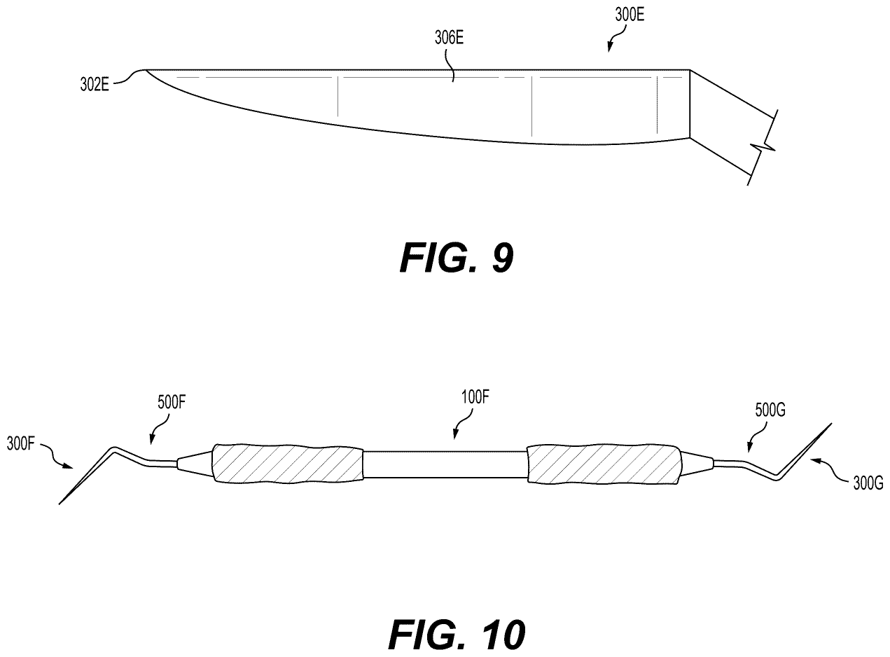

For example, as illustrated in FIG. 9, a sidewall 306E of a dental excavator 300E may be reduced to a point at a first end 302E. All other aspects/features of the dental excavator 300E not described in detail may be similar to or the same as corresponding aspects/features of the dental excavator 300B, except where the context clearly indicates otherwise.

Referring to FIGS. 1 and 3, the inner concave side surface 310 of the sidewall 306 of the dental excavator 300 may face away from the handle 100. For example, the outer convex side surface 320 of the sidewall 306 may be arranged between the inner concave side surface 310 of the first dental excavator 300 and the handle 100. In this configuration, the inner concave side surface 310 of the sidewall 306 is disposed distal to, or faces away from, the handle 100, and the outer convex side surface 320 is disposed proximate to, or faces toward, the handle 100.

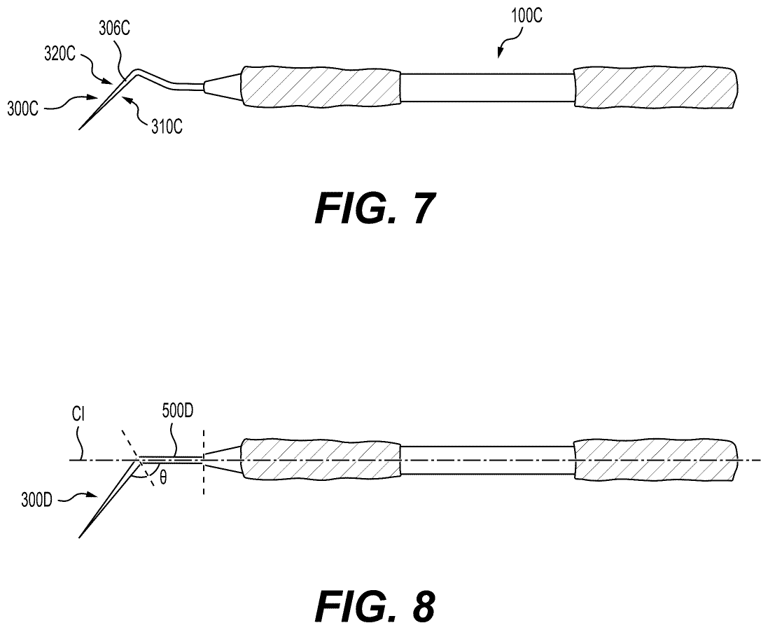

However, the present subject matter is not limited to this configuration. For example, and as illustrated in FIG. 7, an inner concave side surface 310C of a sidewall 306C of a dental excavator 300C may be arranged between an outer convex side surface 320C of the sidewall 306C of the dental excavator 300C and a handle 100C of the dental apparatus. In this configuration, the inner concave side surface 310C of the sidewall 306C is disposed proximal to, or faces toward, the handle 100C, and the outer convex side surface 320C is disposed distal to, or faces away from, the handle 100C.

As illustrated in FIG. 1, first connecting member 500 and the dental excavator 300 may form a z-like shape. In an alternate approach, as illustrated in FIG. 8, a connecting member 500D and a dental excavator 300D may form a v-like shape. The dental apparatus of FIG. 8 may be the same as the dental apparatus of FIG. 1 except for the connecting member 500D of the apparatus of FIG. 8 being straight while the connecting member 500 of the apparatus of FIG. 1 has a bent shape. However, a connecting member of a dental apparatus of the present disclosure is not limited to the bent and straight shapes taught by this specification. A connecting member of a dental apparatus of the present subject matter may have various other shapes that are conducive for use in endodontics.

As more clearly illustrated in FIG. 8, the dental excavator 300D may extend at an angle Θ that is obtuse or at about 90 degrees relative to a central axis CI of a handle 100D of the dental apparatus. Similarly, in the dental apparatus of FIG. 1, the dental excavator 300 may extend at an obtuse angle or at about 90 degrees relative to a central axis of the handle 100.

Therefore, a dental hand apparatus of the present subject matter can have a handle (e.g., as illustrated in FIG. 1) with a connecting member having a configuration as described in this specification (e.g., including, but not limited to the shape of the connecting member 500 or the shape of the connecting member 500D), and a dental excavator connected to the end of the connecting member that is distal to the handle. The dental excavator may have a configuration as described in this specification with reference to FIGS. 1-9.

For example, in a dental apparatus of the present subject matter, the dental excavator attached to the distal end of the connecting member may have a straight profile shape that does not taper to a point as illustrated in FIGS. 1-4, a straight profile shape that tapers to a point as illustrated in FIG. 5, a convex profile shape that does not taper to a point as illustrated in FIG. 6 or a convex profile shape that tapers to a point as illustrated in FIG. 9, whether the dental excavator is oriented to have the inner side surface thereof facing toward the handle or away from the handle, as taught by this specification.

In addition, a dental apparatus of the present subject matter may have a pair of sets of connecting members and dental excavators. Since the handle of a dental apparatus as described in this specification may have a generally elongated shape, the apparatus can be configured to feature a pair of dental excavators connected to opposite ends of the handle to increase the utility of the dental apparatus.

For example, a dental apparatus of this disclosure may include a handle, a first dental excavator, a first connecting member connecting the first dental excavator and the handle to one another, a second dental excavator and a second connecting member connecting the second dental excavator and the handle to one another.

Referring to FIG. 10, a dental apparatus may include a handle 100F, a first dental excavator 300F, a first connecting member 500F connecting the first dental excavator 300F and the handle 100F to one another, a second dental excavator 300G and a second connecting member 500G connecting the second dental excavator 300G and the handle 100F to one another. The first and second connecting members 500F, 500G may be disposed on opposite ends of the handle 100F.

The first dental excavator 300F may be the same as the straight profile dental excavator 300 that does not taper to a point as illustrated in FIGS. 1-4, the same as the straight profile dental excavator 300A that tapers to a point as illustrated in FIG. 5, the same as the convexly-shaped dental excavator 300B that does not taper to a point as illustrated in FIG. 6 or the same as the convexly-shaped dental excavator 300E that tapers to a point as illustrated in FIG. 9, whether the first dental excavator 300F is oriented to have its inner side surface facing toward the handle 100F or facing away from the handle 100F, as taught by this specification.

The first connecting member 500F may have a shape that is the same as the shape of the connecting member 500, the shape of the connecting member 500D, or the shape of a connecting member as otherwise described in this specification.

In addition, the second dental excavator 300G may be the same as the straight profile dental excavator 300 that does not taper to a point as illustrated in FIGS. 1-4, the same as the straight profile dental excavator 300A that tapers to a point as illustrated in FIG. 5, the same as the convexly-shaped dental excavator 300B that does not taper to a point as illustrated in FIG. 6 or the same as the convexly-shaped dental excavator 300E that tapers to a point as illustrated in FIG. 9, whether the second dental excavator 300G is oriented to have its inner side surface facing toward the handle 100F or facing away from the handle 100F, as taught by this specification.

The second connecting member 500G may have a shape that is the same as the shape of the connecting member 500, the shape of the connecting member 500D, or the shape of a connecting member as otherwise described in this specification.

FIG. 10 exemplarily illustrates that the first dental excavator 300F and the first connecting member 500F have the same configuration as the dental excavator 300 and the connecting member 500 of FIGS. 1-4 for convenience of illustration.

Similarly, FIG. 10 exemplarily illustrates that the second dental excavator 300G and the second connecting member 500G have the same configuration as the dental excavator 300 and the connecting member 500 of FIGS. 1-4 for convenience of illustration.

However, and as illustrated in FIG. 10, the second dental excavator 300G and the second connecting member 500G, as a set, may have an orientation that is mirrored about the horizontal axis and mirrored about the vertical axis relative to the orientation of the first dental excavator 300F and the first connecting member 500F, as a set.

Since the dental apparatus of FIG. 10 includes a pair of dental excavators 300F, 300G, the “first direction X” and the “second direction Y”, as taught by this specification, may be used to describe the shape of the first dental excavator 300F. In this case, a “third direction”, analog to the “first direction X” and a “fourth direction”, analog to the “second direction Y” may be used to describe the shape of the second dental excavator 300G.

While FIG. 10 exemplarily illustrates that the first dental excavator 300 may be the same as the second dental excavator 300G, the first dental excavator 300F may also be different from the second dental excavator 300G. In addition, while FIG. 10 exemplarily illustrates that the first connecting member 500F may be the same as the connecting second connecting member 500G, the first connecting member 500F may also be different from the second connecting member 500G.

A dental apparatus as described in this specification can be used to remove small pieces of sealant material adhered to the inner side surface of a root canals in a rapid and safe manner.

A method of using a dental apparatus includes obtaining a dental apparatus as described in this specification. For convenience purposes, the method of using the dental apparatus will be described as being performed by using the dental apparatus of FIGS. 1-4. Therefore, in this example, the method of using a dental apparatus includes obtaining the dental apparatus of FIGS. 1-4.

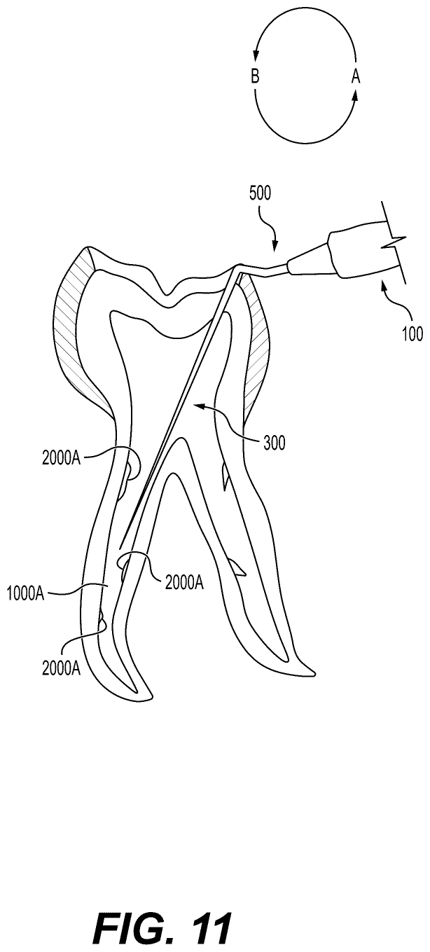

The method of using the dental apparatus includes inserting a dental excavator of the apparatus inside of a dental root canal of a patient. In the example above, the method includes inserting the dental excavator 300 inside of a dental root canal 1000A of a patient's tooth, as illustrated in FIG. 11.

In addition, the method of using the dental apparatus includes rotating the handle of the apparatus in a first rotational direction, thereby causing the first dental excavator to rotate inside of the dental root canal to clean the dental root canal. In the example above, and with reference to FIG. 11, the method includes rotating the handle 100 of the apparatus in a first rotational direction A, thereby causing the dental excavator 300A to rotate inside of the dental root canal 1000A remove (e.g., by scraping) pieces of sealant material 2000A from the inner side surface of the root canal 1000A to dislodge the pieces of sealant material 2000A from the root canal 1000A, thereby cleaning the dental root canal 1000A.

Alternatively, or in addition, the method may include rotating the handle 100 of the apparatus in a second rotational direction B, opposite to the first rotational direction A, to clean the dental root canal 1000A.

While the present disclosure has been particularly shown and described with reference to exemplary embodiments thereof, it will be apparent to those of ordinary skill in the art that various changes in form and detail may be made therein without departing from the spirit and scope of the present disclosure as defined by the following claims.

1. A method of using a dental apparatus, comprising:
obtaining the dental apparatus, said dental apparatus including:
a handle;
a dental excavator; and
a connecting member connecting the dental excavator and the handle to one another,
wherein the dental excavator includes a first end, a second end opposite to the first end, and a sidewall extending between said first and second ends, the second end of the dental excavator being connected to the connecting member,
wherein the sidewall of the dental excavator is curved along a first direction that is transverse to a second direction in which said sidewall extends, said sidewall defining:
an inner side surface of the dental excavator, wherein said inner side surface is concave in the first direction along a length of said sidewall, between the first and second ends of the dental excavator, and
an outer side surface of the dental excavator, disposed opposite to the inner side surface thereof, and extending between the first and second ends of the dental excavator, wherein said outer side surface of the dental excavator is convex in the first direction along the length of said sidewall, between the first and second ends of the dental excavator,
wherein a cross-section of said sidewall tracks along a curved line along the length of said sidewall exposing both said inner side surface and said outer side surface to a dental root canal of a patient,
wherein a thickness of said sidewall separates the inner and outer side surfaces of the dental excavator from one another,
wherein the sidewall of the dental excavator is wider at the second end thereof than at the first end thereof,
wherein the connecting member extends at an obtuse angle or at about 90 degrees relative to a central axis of the handle, and
wherein the dental excavator includes an enhancing coating formed on an exterior of the dental excavator, the enhancing coating reducing friction between the dental excavator and the dental root canal of the patient;
inserting the dental excavator inside of the dental root canal of the patient; and
rotating the handle in a first rotational direction, thereby causing the dental excavator to rotate inside of the dental root canal to clean the dental root canal by dislodging pieces of sealant material using both the outer side surface and the inner side surface.

2. The method of claim 1, wherein a width of the sidewall of the dental excavator is reduced gradually in a direction from the second end thereof toward the first end thereof.

3. The method of claim 1, wherein the sidewall of the dental excavator has a straight profile between the first and second ends of the dental excavator.
